(19) United States
(12) Patent Application Publication
(10) Pub. No.: US 2006/0070239 A1
(43) Pub. Date: Apr. 6, 2006

(54) Shaver with skin tensioner

(76) Inventors: Jordan M. Ries, Tiburon, CA (US); Michael D. Ries, Tiburon, CA (US)

Correspondence Address: Daniel F. Justin;180 South, 600 West, Logan, UT, 84321, US

(21) Appl. No.: 10/956,438

(22) Filed: Oct. 1, 2004

(51) Int. Cl. B26B 19/42

(52) U.S. Cl. 30/34.2

(57) ABSTRACT

Manual razors consist of a handle and one or more cutting blades. The blades are usually contained in the head of the razor with an adjacent blunt metal or plastic leading edge which smoothes and flattens the skin. The present invention includes a separate device attached to the razor handle, which contacts and applies tension to the skin in order for the razor blades to cut more effectively. The tensioner device may be attached directly to the handle or with a modular attachmen, which allows interchangability of different handles.

### BACKGROUND OF THE INVENTION

1. The Field of the Invention

The present invention relates to a manual shaver for shaving skin and methods to flatten and apply tension to the skin during shaving.

2. The Relevant Technology

Manual razor shaving devices typically include a razor head structure with one or more blades attached to a handle. The blades may swivel or rotate perpendicular to the handle to permit closer shaving over contoured areas of skin, or be fixed to the handle without the ability to swivel or rotate.

The razor head which contains the razor blades typically has a blunt metal or plastic leading edge parallel to the blades which contacts the skin before the blade. This feature is intended to flatten the skin during shaving.

In order to shave effectively, the skin should be under tension. This is typically achieved by applying manual traction to the skin in front of the razor or by using facial and neck muscles. Skin traction provides a more rigid counterface for the razor blades to cut against. Similar concepts are employed in techniques used for harvesting skin grafts surgically. A dermatome, which is a device used to remove a uniform thickness of the superficial layer of skin mechanically flattens the skin and applies tension to it.

Current hand held manual razors used for shaving include one or more parallel blades and a metal or plastic leading edge which contacts the skin to smooth it prior to contact by the advancing cutting blade. However, a more effective technique to flatten the skin and increase surface tension would include a non cutting leading edge attached to the handle and separated from the main razor head and cutting blades.

The ideal distance between the main razor head with cutting blades and the separate leading edge to apply tension to the skin is variable and dependent upon the elasticity of the skin and contour of the underlying soft tissues and bone

The separate or leading edge skin tensioner could be directly attached to the razor handle or with a modular sleeve. The modular sleeve would fit different razor handles and allow adjustments in height and position of the skin tensioner.

The position of the leading edge of current razors is dependent upon the position of the razor head. For those which swivel, pressure from the handle against the skin causes tilting of the swivel head with less effective skin flattening than a leading edge attached to the handle. Attachment of the skin tensioner directly to the handle rather than the razor head would allow tension to be applied to the skin by the pressure and direction of the handle, while the cutting blades in the razor head may swivel over the variable contours in the skin surface.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a perspective view shown of the razor handle and skin tensioner device;

FIG. 2 is a side perspective view shown of the razor handle and skin tensioner applied directly to the handle;

FIG. 3 is a bottom perspective view shown of the razor handle and skin tensioner;

### DETAILED DESCRIPTION OF THE PREFERRED EMBODIMENTS

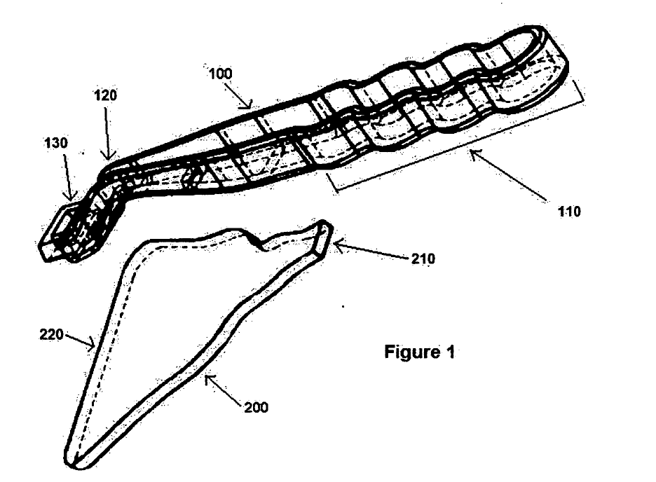

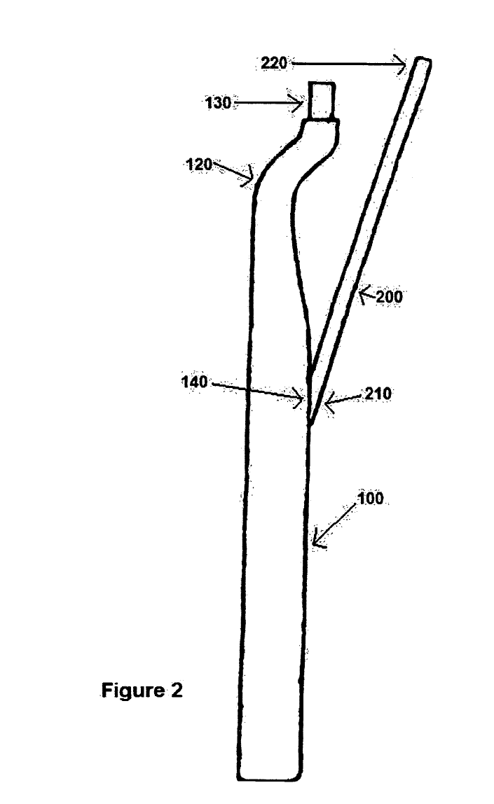

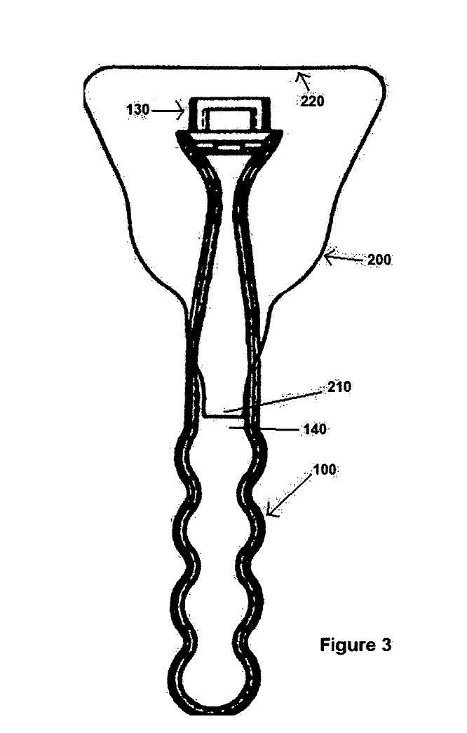

Referring to one or more of the preferred embodiments of the present invention, as depicted in FIG. 1 through FIG. 3, there is a device to apply tension to the skin during shaving. FIG. 1, is a simplified perspective view of the shaver handle and skin tensioner device. The razor handle 100 consists of a proximal handle grip area 110, and a distal curved section 120, which leads to the most distal portion of the handle 130 for attachment to the head containing razor blades. The razor head is not shown to illustrate that the skin tensioner 200 is attached directly to the handle 100. The skin tensioner includes a surface to contact the skin 210 and an area for attachment to the handle 220. FIG. 2 illustrates a side view of the razor handle to show that the skin tensioner device 200 protrudes away from the handle 100 and area of the razor head. The tensioner area for attachment to the handle 210 corresponds to an adjacent area on the handle 140. Alternatively, the skin tensioner 200 could be attached to the handle by a modular sleeve (not shown) or attachment through which the handle passes so that the tensioner could be used with different razor handles. FIG. 3 illustrates a bottom view of the razor handle and skin tensioner device. The area of attachment of the skin tensioner 210 and razor handle 140 are shown in the mid portion of the handle. Alternatively, the attachment could occur at any point on the handle. The skin tensioner is shown as a transparent plastic material, but could also be made of metal or any other material.

While the present invention has been disclosed in its preferred form, the specific embodiments thereof as disclosed and illustrated herein are not to be considered in a limiting sense, as numerous variations are possible. The invention may be embodied in other specific forms without departing from its spirit or essential characteristics. The described embodiments are to be considered in all respects only as illustrative and not restrictive. No single feature, function, element or property of the disclosed embodiments is essential. The scope of the invention is, therefore, indicated by the appended claims rather than by the foregoing description. The following claims define certain combinations and subcombinations that are regarded as novel and non-obvious. Other combinations and subcombinations of features, functions, elements and/or properties may be claimed through amendment of the present claims or presentation of new claims in this or related applications. Such claims, whether they are broader, narrower or equal in scope to the original claims, are also regarded as included within the subject matter of applicant's invention. All changes that come within the meaning and range of equivalency of the claims are to be embraced within their scope.

1. A shaver comprising:
a handle portion having a longitudinal section comprising a distal portion configured to be attached to a head section containing at least one cutting blade, wherein the longitudinal section comprises a minimum width along a direction; and
an extension extending from the longitudinal section of the handle, wherein the extension has a surface that is adapted to contact and flatten the skin;
wherein the surface extends parallel to the direction along a length greater than the minimum width;
wherein the surface is substantially non-rotating with respect to the handle portion.

2. A shaver as in claim 1, wherein the extension is substantially transparent.

3. A shaver as in claim 1, wherein the extension is adjacent to the head section.

4. A shaver as in claim 1, wherein the extension is formed substantially of a plastic material.

5. A shaver as in claim 1, wherein the extension is mechanically attached to the handle portion.

6. A shaver as in claim 1, wherein the extension is formed of a single piece of material.

7. A shaver as in claim 1, wherein the cutting blade is non-motorized.

8. A shaver comprising:
a handle portion having a longitudinal section;
a head section containing at least one cutting blade, wherein the head section is attached to the end of the handle;
an extension positionable to extend from the longitudinal section of the handle, wherein the extension is substantially transparent and has a plastic surface that is adapted to contact and flatten the skin.

9. A shaver as in claim 8, wherein the surface is relatively parallel to the head section.

10. A shaver as in claim 8, wherein the extension is adjacent to the head section.

11. (canceled)

12. A shaver as in claim 8, wherein the extension is mechanically attached to the handle portion.

13. A shaver as in claim 8, wherein the extension is formed of a single piece of material.

14-20. (canceled)
